(19) United States
(12) Patent Application Publication
(10) Pub. No.: US 2020/0241443 A1
(43) Pub. Date: Jul. 30, 2020

(54) IMAGE FORMING APPARATUS AND CONTROL METHOD

(71) Applicant: Konica Minolta, Inc., Tokyo (JP)

(72) Inventor: Kazuki KOBORI, Toyokawa-shi (JP)

(21) Appl. No.: 16/727,090

(22) Filed: Dec. 26, 2019

(30) Foreign Application Priority Data
Jan. 24, 2019 (JP) 2019-010244

(51) Int. Cl. G03G 15/08; G03G 21/20

(52) U.S. Cl. CPC G03G 15/0877; G03G 21/20; G03G 2215/0685; G03G 15/0853; G03G 15/0808; G03G 15/0868

(57) ABSTRACT

An image forming apparatus includes: a latent image carrier on which a latent image is formed; a developing device that develops the latent image formed on the latent image carrier, using developer; a supply member that supplies the developer to the developing device; and a hardware processor that: performs control of the supply member; and acquires an atmospheric pressure value in a position where the image forming apparatus is installed, wherein the hardware processor changes a method of controlling the supply member based on the atmospheric pressure value acquired by the hardware processor.

The entire disclosure of Japanese patent Application No. 2019-010244, filed on Jan. 24, 2019, is incorporated herein by reference in its entirety.

### BACKGROUND

### Technological Field

The present disclosure relates to an image forming apparatus and a control method.

### Description of the Related Art

Image forming apparatuses using an electrophotographic method such as copiers, printers, facsimile machines, and machines combining them are known. An image forming apparatus generally includes a developing device, a supply unit, and a sensor. The developing device develops a latent image formed on a photoconductor. The supply unit supplies developer to the developing device. The sensor detects the concentration of the developer (e.g., toner concentration).

An image forming apparatus described in JP 61-34569 A sets, as thresholds of the concentration of developer in a developing device, a first threshold value and a second threshold value smaller than the first threshold value. When a concentration detected by a sensor is equal to or higher than the first threshold value, the developing device is not supplied with developer. When the concentration detected by the sensor is equal to or higher than the second threshold value and less than the first threshold value, the developing device is supplied with a first amount of developer. When the concentration detected by the sensor is less than the second threshold value, the developing device is supplied with a second amount of developer larger than the first amount.

However, the image forming apparatus described in JP 61-34569 A does not consider the atmospheric pressure value in the place where the image forming apparatus is installed. The bulk density of the developer generally varies, depending on the atmospheric pressure value in the place where the image forming apparatus is installed. Therefore, when the supply unit supplies the developer to the developing device, an amount of developer different from an expected amount may be supplied, depending on the atmospheric pressure value, which results in a problem that the expected amount of developer cannot be supplied to the developing device.

### SUMMARY

The present disclosure has been made to solve problems as described above, and its object in one aspect is to provide an image forming apparatus and a control method that can supply a proper amount of developer to a developing device, taking the atmospheric pressure value in the position where the image forming apparatus is installed into account.

To achieve the abovementioned object, according to an aspect of the present invention, an image forming apparatus reflecting one aspect of the present invention comprises: a latent image carrier on which a latent image is formed; a developing device that develops the latent image formed on the latent image carrier, using developer; a supply member that supplies the developer to the developing device; and a hardware processor that: performs control of the supply member; and acquires an atmospheric pressure value in a position where the image forming apparatus is installed, wherein the hardware processor changes a method of controlling the supply member based on the atmospheric pressure value acquired by the hardware processor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing an example of an internal structure of an image forming apparatus of an embodiment;

FIG. 2 is a diagram showing an example of a developing device;

FIG. 3 is a block diagram showing a hardware configuration of the image forming apparatus;

FIG. 4 is a perspective view of a toner bottle of the embodiment;

FIG. 5 is a diagram showing principal parts of the image forming apparatus of the embodiment;

FIG. 6 is a diagram showing supply amount, etc.;

FIG. 7 is a diagram showing supply amount, atmospheric pressure value, etc.;

FIG. 8 is a diagram showing a functional configuration example of a controller;

FIG. 9 is a flowchart of the image forming apparatus of the embodiment;

FIG. 10 is a diagram showing an example of a toner bottle of another embodiment;

FIG. 11 is a diagram showing principal parts of an image forming apparatus of another embodiment;

FIG. 12 is a diagram showing supply amount, atmospheric pressure value, etc. of the other embodiment;

FIG. 13 is a flowchart of the image forming apparatus of the embodiment;

FIG. 14 is a diagram showing an example of an image forming system; and

FIG. 15 is a diagram showing an example of a table held by a server device.

### DETAILED DESCRIPTION OF EMBODIMENTS

Hereinafter, one or more embodiments of the present invention will be described with reference to the drawings. However, the scope of the invention is not limited to the disclosed embodiments. In the following descriptions, the same reference numerals are assigned to the same parts and components. Their names and functions are also the same. Therefore, they will not be repeatedly described in detail. The embodiments and modifications described below may be selectively combined as appropriate.

### First Embodiment

[Internal Structure of Image Forming Apparatus]

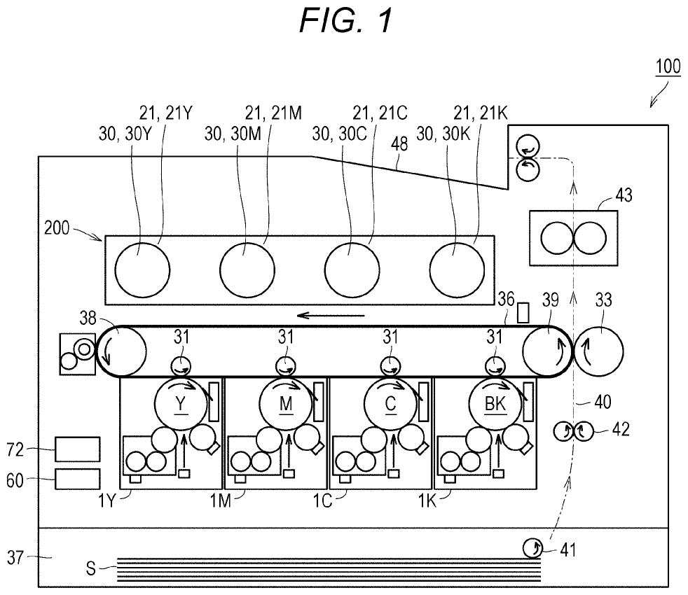

The internal structure of an image forming apparatus 100 will be described with reference to FIG. 1. FIG. 1 is a diagram showing an example of the internal structure of the image forming apparatus 100.

FIG. 1 shows the image forming apparatus 100 as a color printer. Hereinafter, the image forming apparatus 100 as a color printer will be described, but the image forming apparatus 100 is not limited to a color printer. For example, the image forming apparatus 100 may be a monochrome printer, a copier, a facsimile machine, or a multi-functional peripheral (MFP). In the present embodiment, developer is toner.

The image forming apparatus 100 includes image forming units 1Y, 1M, 1C, and 1K, an intermediate transfer belt 36, primary transfer rollers 31, a secondary transfer roller 33, a cassette 37, a driven roller 38, a drive roller 39, a pickup roller 41, a timing roller 42, and a fixing device 43.

The image forming units 1Y, 1M, 1C, and 1K are aligned in order along the intermediate transfer belt 36. The image forming unit 1Y forms a yellow (Y) toner image. The image forming unit 1M forms a magenta (M) toner image. The image forming unit 1C forms a cyan (C) toner image. The image forming unit 1K forms a black (BK) toner image.

The image forming units 1Y, 1M, 1C, and 1K and the intermediate transfer belt 36 are in contact with each other at portions where the primary transfer rollers 31 are provided. The primary transfer rollers 31 are rotatable. A transfer voltage of polarity opposite to that of toner images is applied to the primary transfer rollers 31, thereby transferring the toner images from the image forming units 1Y, 1M, 1C, and 1K to the intermediate transfer belt 36.

In a color print mode, a yellow (Y) toner image, a magenta (M) toner image, a cyan (C) toner image, and a black (BK) toner image are sequentially superimposed and transferred to the intermediate transfer belt 36. Thus, a color toner image is formed on the intermediate transfer belt 36. On the other hand, in a monochrome print mode, a black (BK) toner image is transferred from a photoconductor 10 (latent image carrier) to the intermediate transfer belt 36.

The intermediate transfer belt 36 is stretched between the driven roller 38 and the drive roller 39. The drive roller 39 is rotationally driven, for example, by a motor (not shown). The intermediate transfer belt 36 and the driven roller 38 rotate in conjunction with the drive roller 39. Thus, a toner image on the intermediate transfer belt 36 is conveyed to the secondary transfer roller 33.

Sheets of paper S are set in the cassette 37. The sheets of paper S are conveyed from the cassette 37 one by one by the pickup roller 41 and the timing roller 42 to the secondary transfer roller 33 along a conveyance path 40. The secondary transfer roller 33 applies a transfer voltage of polarity opposite to that of the toner image to a sheet of paper S being conveyed. Consequently, the toner image is attracted from the intermediate transfer belt 36 to the secondary transfer roller 33 and transferred to a proper position on the sheet of paper S.

The fixing device 43 pressurizes and heats the sheet of paper S passing therethrough. Consequently, the toner image formed on the sheet of paper S is fixed to the sheet of paper S. Thereafter, the sheet of paper S is discharged to a tray 48.

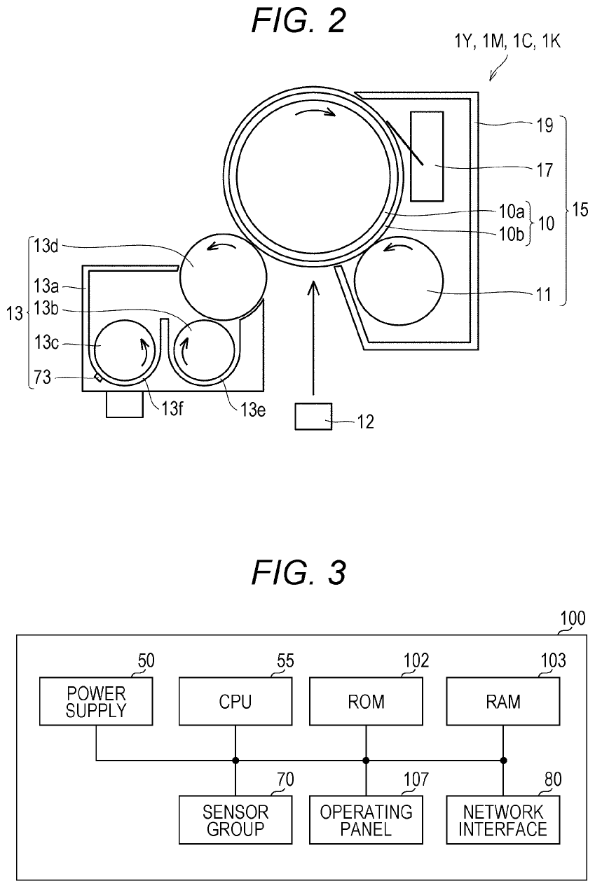

Next, a toner supply unit 200 will be described. The image forming apparatus 100 further includes the toner supply unit 200. The toner supply unit 200 is a device for supplying toner to a developing device 13 (see FIG. 2). The toner supply unit 200 is provided between the intermediate transfer belt 6 and the tray 48 in a vertical direction.

The toner supply unit 200 includes a bottle holder 21 (21Y, 21M, 21C, and 21K) for each color, and a toner bottle 30 (30Y, 30M, 30C, and 30K) for each color. The toner bottle 30 is also referred to as a supply member.

The toner bottle 30 contains toner to be supplied to the developing device 13. The toner bottle 30Y, the toner bottle 30M, the toner bottle 30C, and the toner bottle 30K are provided for the developing devices 13 of the image forming unit 12Y, the image forming unit 12M, the image forming unit 12C, and the image forming unit 12K, respectively. That is, the toner bottle 30Y, the toner bottle 30M, the toner bottle 30C, and the toner bottle 30K contain toner of yellow (Y), magenta (M), cyan (C), and black (K).

The bottle holder 21 is fixed to the image forming apparatus 100. The toner bottle 30 is removably provided in the bottle holder 21. The bottle holder 21 can hold the toner bottle 30. The bottle holder 21Y, the bottle holder 21M, the bottle holder 21C, and the bottle holder 21K are provided for the toner bottle 30Y, the toner bottle 30M, the toner bottle 30C, and the toner bottle 30K, respectively.

When the image forming apparatus 100 is in operation, the toner is supplied to the developing device 13 from the toner bottle 30 fitted in the bottle holder 21. When the toner in the toner bottle 30 is reduced, the user removes the toner bottle 30 from the bottle holder 21 and fits a new toner bottle 30 into the bottle holder 21.

[Internal Structure of Image Forming Units]

With reference to FIG. 2, the internal structure of the image forming units 1Y, 1M, 1C, and 1K will be described. FIG. 2 is a diagram showing an example of the internal structure of the image forming units 1Y, 1M, 1C, and 1K.

As shown in FIG. 2, the image forming units 1Y, 1M, 1C, and 1K each include a drum unit 15, an exposure device 12, and the developing device 13.

The drum unit 15 includes the photoconductor 10, a charging device 11, a cleaning device 17, and a support 19.

The support 19 supports the photoconductor 10, the charging device 11, and the cleaning device 17 to unitize these members.

The photoconductor 10 includes a drum-shaped (cylindrical) base 10a made of aluminum or the like, and a photoconductive layer 10b formed on the outer peripheral surface of the base 10a. A toner image is formed on the outer peripheral surface of the photoconductor 10.

The charging device 11 is a roller that negatively charges the peripheral surface of the photoconductor 10 uniformly. The charging device 11 has a long shape along the rotation axis of the photoconductor 10. The rotation axis of the charging device 11 is parallel to the rotation axis of the photoconductor 10.

The charging device 11 includes a cylindrical shaft having rigidity using a metal (e.g., a stainless material), and an elastic layer made of a conducting or semiconducting elastic material formed on the peripheral surface of the shaft.

The cleaning device 17 is pressed against the photoconductor 10. The cleaning device 17 collects toner remaining on the surface of the photoconductor 10 after a toner image transfer.

The exposure device 12 irradiates the photoconductor 10 with laser light in response to a control signal from a controller 60 described later, to expose the surface of the photoconductor 10 according to an input image pattern. Consequently, a charge generation layer of the photoconductive layer 10b generates a charge at an exposed portion. The absolute value of the surface potential (negative polarity) of the exposed portion becomes lower than the absolute value of the surface potential (negative polarity) of an unexposed portion. Thus, an electrostatic latent image corresponding to the input image is formed on the photoconductor 10.

In the present embodiment, the developing device 13 develops the electrostatic latent image formed on the surface of the photoconductor 10 with toner (using toner). The developing device 13 includes a developer tank 13a, a pair of stirring screws 13b and 13c, a toner concentration sensor 73, and a developing roller 13d. As the developing device 13 develops the electrostatic latent image, the toner in the developing device 13 decreases.

The developer tank 13a contains dual-component developer composed of non-magnetic toner and a carrier formed of ferrite powder, iron powder, or the like. The developer tank 13a has two holding chambers 13e and 13f along the axial direction of the photoconductor 10. The two holding chambers 13e and 13f communicate with each other at both ends. The stirring screws 13b and 13c are disposed in the holding chambers 13e and 13f, respectively. By rotating the stirring screws 13b and 13c, the dual-component developer held in the holding chambers 13e and 13f is stirred in the course of circulating between the holding chamber 13e and the holding chamber 13f, and the toner and the carrier are mixed and friction-charged.

Resin particles constituting the toner and the material of resin coating the surface of the carrier used as the dual-component developer in the present embodiment are selected such that the toner has negatively charged characteristics, and the carrier has positively charged characteristics. Consequently, by being rubbed by stirring, the toner is negatively charged and the carrier is positively charged. The negatively charged toner adheres to the periphery of the positively charged carrier.

The developing roller 13d is a non-magnetic cylindrical member using, for example, a stainless material. The developing roller 13d contains a plurality of magnets having magnetic poles (not shown), and is rotationally driven, keeping a small distance from the photoconductor 10.

The dual-component developer conveyed in the axial direction of the stirring screw 13b in the holding chamber 13e, that is, the carrier to which the toner is attached adheres to the peripheral surface of the developing roller 13d due to the magnets contained in the developing roller 13d.

The rotating developing roller 13d conveys the dual-component developer adhering to the peripheral surface thereof to a position (developing area) opposite to the photoconductor 10.

A voltage supplied from a power supply 50 described later is applied to the developing roller 13d. A voltage with an AC voltage superimposed on a DC voltage is applied to the developing roller 13d. When an electrostatic latent image formed portion reaches the position (developing area) opposite to the developing roller 13d by the rotation of the photoconductor 10, the toner (negatively charged) separates from the carrier, moving from the peripheral surface of the developing roller 13d to the photoconductor 10. At this time, the carrier is attracted to the developing roller 13d by the magnetic force of the magnets contained in the developing roller 13d, and does not move to the photoconductor 10. Thus, the toner is transferred from the developing roller 13d to the photoconductor 10, and a toner image corresponding to the electrostatic latent image is developed on the surface of the photoconductor 10.

The toner concentration sensor 73 detects the toner concentration of the dual-component developer in the developer tank 13a. The toner concentration is also referred to as “Tc”. The toner concentration sensor 73 typically includes a magnetic permeability sensor. The toner concentration sensor 73 measures magnetic permeability in a processing area where the toner is present in the developing device 13. The carrier is mainly formed of iron. When the magnetic permeability is high, the carrier is estimated to be large in amount, and thus Tc is low. On the other hand, when the magnetic permeability is low, the carrier is estimated to be small in amount, and thus Tc is high. The toner concentration sensor 73 converts the magnetic permeability detected by the magnetic permeability sensor into Tc. A conversion method may be, for example, a method using a predetermined equation. Another conversion method may be, for example, a method using a predetermined table. Conversion from magnetic permeability into Tc may be performed by the controller 60.

The toner concentration typically means (toner weight)/(toner weight+carrier weight). For the toner concentration in the developer tank 13a, a proper range is determined in advance. The proper range includes a lower limit and an upper limit. For example, the lower limit is 5 pts. wt., and the upper limit is 8 pts. wt. “Tc is lower than the proper range” means that Tc is lower than the lower limit. “Tc is higher than the proper range” means that Tc is higher than the upper limit.

When the image forming apparatus 100 performs print processing with Tc lower than the proper range, the toner amount of an image developed is small, and the density of an image printed is lower than a proper density. The proper density is, for example, a density specified (input) by the user.

On the other hand, with Tc higher than the proper range, the toner may not be sufficiently stirred against the carrier. In this case, the amount of charge to the toner decreases, and the toner scatters from the developing device 13. When the toner scatters from the developing device 13, the toner is added, for example, to the inside of the image forming apparatus 100 or a background portion of an image (a portion to which the toner should not be added), causing a phenomenon such as an image defect. Therefore, it is preferable that Tc falls within the proper range.

[Hardware Configuration of Image Forming Apparatus]

With reference to FIG. 3, an example of a hardware configuration of the image forming apparatus 100 will be described. FIG. 3 is a block diagram showing a principal hardware configuration of the image forming apparatus 100.

As shown in FIG. 3, the image forming apparatus 100 includes the power supply 50, a central processing unit (CPU) 55, a sensor group 70, read-only memory (ROM) 102, random-access memory (RAM) 103, an operating panel 107, and a network interface 80.

The power supply 50 supplies power to the components of the image forming apparatus 100 (e.g., the charging device 11 and the developing device 13 in FIG. 2). The CPU 55 executes programs. The ROM 102 stores data in a nonvolatile manner. The RAM 103 stores data in a volatile manner.

The sensor group 70 includes a plurality of sensors that measure various physical quantities in the image forming apparatus 100. The sensor group 70 includes an atmospheric pressure sensor 72 and the toner concentration sensor 73 shown in FIG. 2.

The operating panel 107 includes a display and a touch panel. The display and the touch panel are placed on each other. The operating panel 107 receives, for example, commands (e g, a print command and a scan command) from the user to the image forming apparatus 100.

The network interface 80 is connected to a network. The image forming apparatus 100 can communicate with external devices via the network interface 80. The external devices include, for example, a mobile communication terminal such as a smartphone, a server, etc.

[Toner Bottle Structural Example]

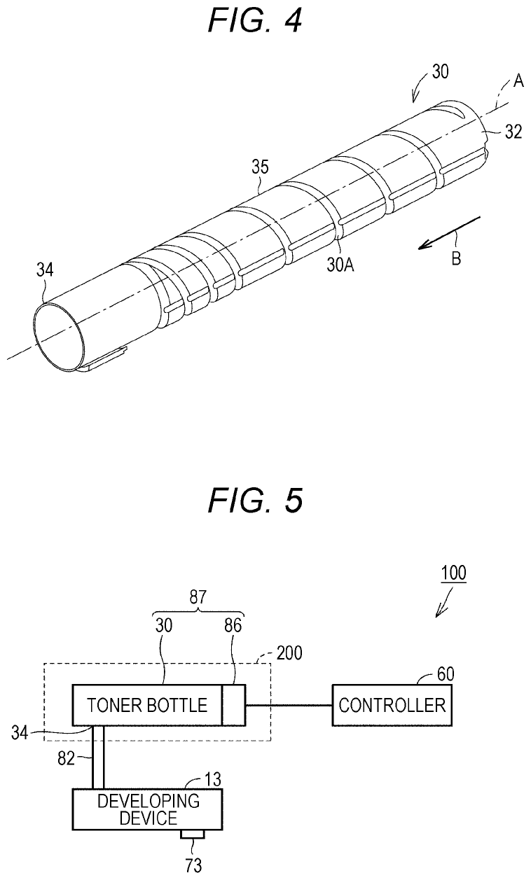

Next, with reference to FIG. 4, a structural example of the toner bottle 30 will be described. FIG. 4 is an example of a perspective view of the toner bottle 30. The toner bottle 30 includes a bottle body 35, an opening 34, and a bottom 32.

The toner bottle 30 can be rotated by the controller 60 about a virtual rotation axis A. In the example of FIG. 4, the toner bottle 30 extends along the rotation axis A. In the example of FIG. 4, the bottle body 35 has a cylindrical shape. The opening 34 is formed at one end of the toner bottle 30. The other end of the toner bottle 30 is the bottom 32. The toner in the toner bottle 30 is supplied to the developing device 13 through the opening 34.

A spiral groove 30A is formed on the outer periphery of the bottle body 35 along the rotation axis A. The groove 30A forms a spiral protruding portion on the inner wall (inner peripheral side) of the bottle body 35 along the rotation axis A. The protruding portion is for moving the toner in the toner bottle 30 from the bottom 32 side toward the opening 34 (in the direction of arrow B in FIG. 4) by the rotation of the toner bottle 30. The moved toner is supplied to the developing device 13 through the opening 34 and a supply path 82 shown in FIG. 5 described later. The toner bottle may have another shape as long as it is a shape for supplying the toner to the developing device 13 by rotation.

[Principal Parts of Image Forming Apparatus]

FIG. 5 is a diagram showing simplified principal parts of the image forming apparatus 100 of the present embodiment. The example of FIG. 5 shows the toner supply unit 200, the developing device 13, the controller 60, and the supply path 82. The toner supply unit 200 includes the toner bottle 30 and a drive unit 86. The toner bottle 30 and the drive unit 86 are also collectively referred to as a “supply member 87”. The supply path 82 is connected to the opening 34.

The drive unit 86 rotationally drives the toner bottle 30 under the control of the controller 60 (a supply amount control unit 61). As the toner bottle 30 rotates, the toner in the toner bottle is supplied to the developing device 13 via the opening 34 and the supply path 82. As also shown in FIG. 2, the toner concentration sensor 73 is disposed at the developing device 13. In the example of FIG. 4, an example in which the opening 34 is formed at one end of the toner bottle 30 has been described. FIG. 5 shows an example in which the opening 34 is disposed on the drive unit 86 side for convenience.

[About Toner Supply]

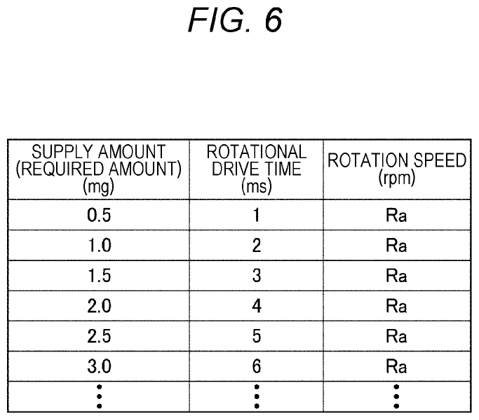

FIG. 6 is a table in which toner supply amount (mg) and parameters related to control by the supply amount control unit 61 when the image forming apparatus 100 is installed on level ground are associated with each other. In the example of FIG. 6, the parameters related to the control include a control value and a control time.

The control value in the example of FIG. 6 is the rotation speed of the toner bottle 30 (the unit is rotations per minute (rpm)). The control time in the example of FIG. 6 is the rotation time of the toner bottle 30 (the unit is ms).

Here, the supply amount in FIG. 6 is an amount when the atmospheric pressure value in the place where the image forming apparatus 100 is installed is a reference value, and the toner bottle 30 contains a predetermined amount or larger of toner. The predetermined amount is, for example, an amount sufficient for the toner to be supplied to the developing device 13 by the rotation of the toner bottle 30. The reference value is, for example, 1 atm. The case where the atmospheric pressure value in the place where the image forming apparatus 100 is installed is 1 atm is, for example, the case where the image forming apparatus 100 is installed on level ground.

When the controller 60 determines that Tc acquired by the toner concentration sensor 73 does not fall within the proper range, the controller 60 specifies an amount necessary for Tc to fall within the proper range. “The amount necessary for Tc to fall within the proper range” is, in other words, a “required amount required from the toner bottle 30 to the developing device 13”.

The controller 60 supplies the required amount (amount to be supplied) of toner from the toner bottle 30 to the developing device 13 by controlling the drive unit 86.

In the example of FIG. 6, for example, for a required amount of toner of 0.5 mg, it is determined that the rotational drive time of the toner bottle 30 is 1 ms and the rotation speed is Ra. In the example of FIG. 6, for a required amount of toner of 1.0 mg, it is determined that the rotational drive time of the toner bottle 30 is 2 ms, and the rotation speed is Ra.

Thus, in the example of FIG. 6, when the toner bottle 30 contains the predetermined amount or larger of toner, for example, by rotating the toner bottle 30 at the rotation speed Ra for a rotational drive time of 1 ms, 0.5 mg of toner is supplied to the developing device 13.

In the example of FIG. 6, the larger the toner supply amount, the longer the rotational drive time is set to be. In the example of FIG. 6, it is determined that the rotation speed is uniform regardless of the toner supply amount.

In FIG. 6, when the required amount is a first amount (e.g., 0.5 mg), the controller 60 performs control to supply the first amount. In the example of FIG. 6, the control to supply the first amount is control to rotationally drive the toner bottle 30 with the rotation speed set to Ra and the rotational drive time of the toner bottle 30 to 1 ms.

In FIG. 6, when the required amount is a second amount larger than the first amount (e.g., 1.0 mg), the controller 60 performs control to supply the second amount. In the example of FIG. 6, the control to supply the second amount is control to rotationally drive the toner bottle 30 with the rotation speed set to Ra and the rotational drive time of the toner bottle 30 to 2 ms.

Incidentally, the image forming apparatus 100 may be installed in a position where the pressure value is not the reference value. The position is, for example, high ground.

Here, the relationship between the atmospheric pressure value and the toner will be described. For example, the case where the image forming apparatus 100 is installed in a first position is compared with the case where the image forming apparatus 100 is installed in a second position where the atmospheric pressure value is lower than that in the first position. The first position is, for example, a level ground position, and the second position is, for example, a high-altitude position (high ground).

The toner is composed of a lot of toner powder in powder form. That is, the toner bottle 30 contains a lot of toner powder as toner. The atmospheric pressure in the second position is lower than that in the first position. Thus, the distance between toner powder particles in adjacent positions is longer in the second position than in the first position. Consequently, the bulk density of the toner contained in the toner bottle 30 is lower in the second position than in the first position.

When the image forming apparatus 100 is installed in the first position, and the required amount of toner is 1.0 mg, for example, the controller 60 can supply 1.0 mg of toner properly by rotating the toner bottle 30 at the rotation speed Ra for 2 ms.

On the other hand, when the image forming apparatus 100 is installed in the second position, and the required amount of toner is 1.0 mg, for example, the controller 60 cannot supply 1.0 mg of toner properly even by rotating the toner bottle 30 at the rotation speed Ra for 2 ms.

The reason will be described below. As described above, when the image forming apparatus 100 is installed in the second position, the atmospheric pressure is lower than when the image forming apparatus 100 is installed in the first position. Thus, when the image forming apparatus 100 is installed in the second position, the bulk density of the toner contained in the toner bottle 30 is lower than when the image forming apparatus 100 is installed in the first position. Consequently, even if drive to supply 1.0 mg of toner based on the table of FIG. 6 (drive to rotate the toner bottle 30 at the rotation speed Ra for 2 ms) is performed, actually, an amount of toner smaller than 1.0 mg is supplied to the developing device 13.

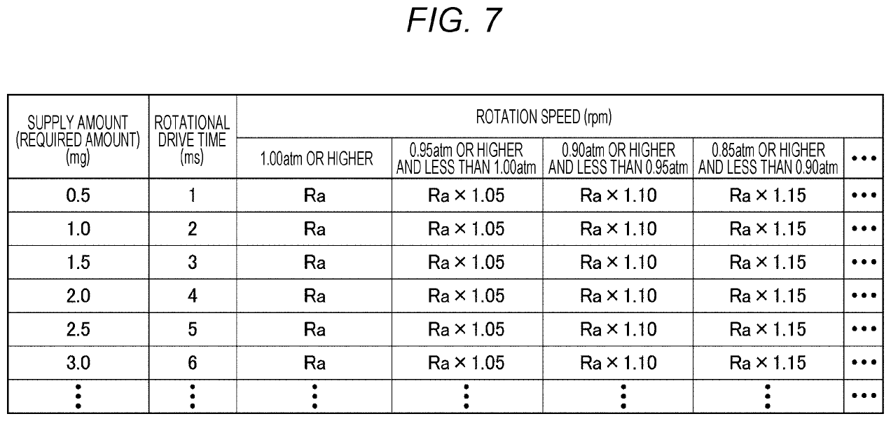

Therefore, the supply amount control unit 61 of the present embodiment corrects a drive value by multiplying the drive value by a correction value C. The correction value C is typically a value larger than one. FIG. 7 is an example of a table used for this correction. This table is created in advance and is stored in the storage unit 62.

In the table, the rotational drive time T of the toner bottle 30 and the rotation speed R of the toner bottle 30 are associated with the toner supply amount (mg). Further, the correction value C of the rotation speed is determined according to the pressure value.

In the example of FIG. 7, regardless of the toner supply amount, when an atmospheric pressure value P under which the image forming apparatus 100 is disposed is 1.00 atm or higher, the correction value C is set to “1”. When the atmospheric pressure value P is 0.95 atm or higher and less than 1.00 atm, the correction value C is set to “1.05”. When the atmospheric pressure value P is 0.90 atm or higher and less than 0.95 atm, the correction value C is set to “1.10”. When the atmospheric pressure value P is 0.85 atm or higher and less than 0.9 atm, the correction value C is set to “1.15”.

[Controller Functional Configuration Example]

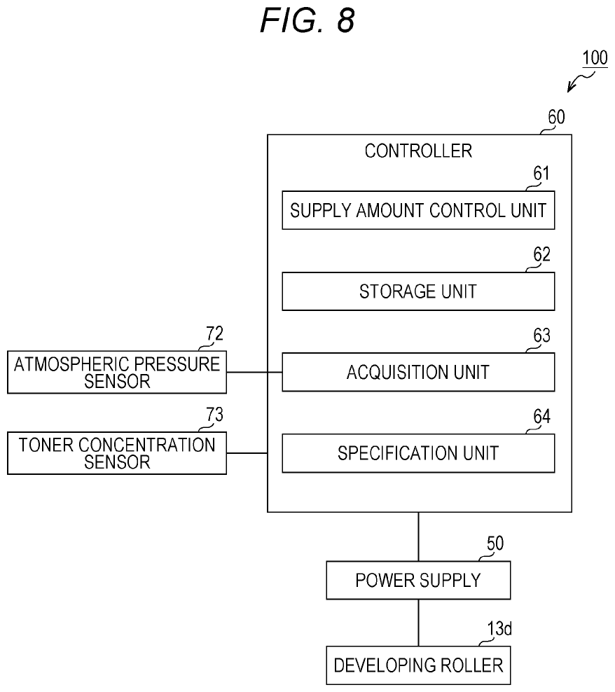

Next, the controller 60 of the image forming apparatus 100 and others will be described. The controller 60 includes the CPU 55, the ROM 102, the RAM 103, etc. FIG. 8 is a diagram for explaining the controller 60 and others.

The power supply 50 applies a voltage to the developing roller 13d. Here, the power supply 50 applies a development voltage that is a negative DC voltage to the developing roller 13d.

The surface potential of the photoconductor 10 (see FIG. 2) is negative. The absolute value of the surface potential of a portion exposed by the exposure device 12 is lower than the absolute value of the development voltage. On the other hand, the absolute value of the surface potential of a portion not exposed by the exposure device 12 is higher than the absolute value of the development voltage. Thus, the toner with negative potential is transferred from the developing roller 13d only to the exposed portion of the photoconductor 10. Consequently, a toner image is formed on the photoconductor 10.

The atmospheric pressure sensor 72 detects the atmospheric pressure value in the position where the image forming apparatus 100 is installed. The controller 60 has the functions of the supply amount control unit 61, the storage unit 62, an acquisition unit 63, and a specification unit 64. The acquisition unit 63 acquires the atmospheric pressure value detected by the atmospheric pressure sensor 72, and the toner concentration detected by the toner concentration sensor 73. The storage unit 62 stores various kinds of information. The storage unit 62 stores, for example, a first table and a table.

The specification unit 64 calculates, from a job input by the user or the like, a toner amount used in the job (hereinafter referred to as a “used toner amount”). The specification unit 64 functions as a calculation unit that calculates the used toner amount.

The specification unit 64 also functions as a toner concentration acquisition unit that acquires Tc detected by the toner concentration sensor 73. The specification unit 64 determines whether it is necessary to supply the toner, based on a toner amount based on the acquired Tc and the calculated used toner amount.

For example, as shown in equation (1) below, by subtracting the used toner amount calculated by the specification unit 64 from the toner amount based on Tc acquired by the specification unit 64, the toner amount after the subtraction is calculated.

Toner amount after subtraction=toner amount based on acquired Tc−used toner amount (1)

The specification unit 64 determines whether the toner amount after the subtraction falls below the proper range of the toner amount. When the specification unit 64 determines that the toner amount after the subtraction falls below the proper range, the specification unit 64 determines that an amount of toner should be supplied. In other words, when the specification unit 64 determines that the toner amount after the subtraction falls below the proper range, the specification unit 64 determines that it is necessary to supply the toner to the developing device 13. In other words, the specification unit 64 determines that there is a “required amount required from the toner bottle 30 to the developing device 13”. In other words, the specification unit 64 determines that there is not enough toner in the developing device 13.

Further, the specification unit 64 specifies the amount (required amount) of toner to be supplied from the toner bottle 30 to the developing device 13. Hereinafter, the amount of toner to be supplied from the toner bottle 30 to the developing device 13 is referred to as a “toner supply amount”.

The specification unit 64 calculates the toner supply amount based, for example, on equation (2) below.

Toner supply amount=reference toner amount based on reference parts by weight−toner amount after subtraction (2)

Thus, the specification unit 64 specifies the amount of toner to be supplied from the toner bottle 30 to the developing device 13, based on equation (2). For equations (1) and (2), the present invention is not limited to these equations, and may use other equations. Although equations (1) and (2) are equations based on the toner amount, at least one of equations (1) and (2) may be an equation based on another parameter (e.g., toner concentration).

On the other hand, when the specification unit 64 determines that the toner amount after the subtraction falls within the proper range, the specification unit 64 determines that no toner amount should be supplied.

The supply amount control unit 61 controls the amount of supply of the toner per unit time to the developing device 13 by the toner bottle. Here, the unit time may be any time, for example, one second or ten seconds. The supply amount control unit 61 controls the drive unit 86 to control the supply amount per unit time.

For example, when the acquisition unit 63 acquires 1 atm as the atmospheric pressure value, and the toner supply amount specified by the specification unit 64 is 1 mg, control to supply 1 mg from the toner bottle 30 to the developing device 13 is performed. In the present embodiment, the control is control by the supply amount control unit 61 to generate a control signal for rotating the toner bottle 30 at the rotation speed Ra for 2 ms, and transmit the control signal to the drive unit 86.

When the acquisition unit 63 acquires 1 atm as the atmospheric pressure value, and the toner supply amount specified by the specification unit 64 is 2 mg, control to supply 2 mg from the toner bottle 30 to the developing device 13 is performed. In the present embodiment, the control is control by the supply amount control unit 61 to generate a control signal for rotating the toner bottle 30 at the rotation speed Ra for 4 ms, and transmit the control signal to the drive unit 86.

When the acquisition unit 63 acquires 0.93 atm as the atmospheric pressure value, and the toner supply amount specified by the specification unit 64 is 1 mg, control to supply a toner amount larger than 1 mg from the toner bottle 30 to the developing device 13 is performed. In the present embodiment, the control is control by the supply amount control unit 61 to generate a control signal for rotating the toner bottle 30 at a rotation speed Ra×1.1 for 2 ms, and transmit the control signal to the drive unit 86.

When the acquisition unit 63 acquires 0.93 atm as the atmospheric pressure value, and the toner supply amount specified by the specification unit 64 is 2 mg, control to supply a toner amount larger than 2 mg from the toner bottle 30 to the developing device 13 is performed. In the present embodiment, the control is control by the supply amount control unit 61 to generate a control signal for rotating the toner bottle 30 at the rotation speed Ra×1.1 for 4 ms, and transmit the control signal to the drive unit 86.

Hereinafter, the control by the supply amount control unit 61 to generate a control signal and transmit the control signal to the drive unit 86, to cause the drive unit 86 to rotationally drive the toner bottle 30 is described as “the supply amount control unit 61 performs control on the supply member 87”.

In the present embodiment, an atmospheric pressure value of 1 atm is also referred to as a “first atmospheric pressure value”, and an atmospheric pressure value lower than 1 atm is also referred to as a “second atmospheric pressure value”.

When the atmospheric pressure value acquired by the acquisition unit 63 is the first atmospheric pressure value, the supply amount control unit 61 performs a first control on the supply member 87. The first control is control to supply the same toner supply amount of toner as the toner supply amount specified by the specification unit 64 to the developing device 13. In other words, the first control is control by the supply amount control unit 61 to transmit, to the drive unit 86, a control signal for supplying the same toner supply amount of toner as the toner supply amount specified by the specification unit 64 to the developing device 13. The “control to supply the same toner supply amount of toner as the toner supply amount specified by the specification unit 64 to the developing device 13” is based on the fact that when the atmospheric pressure value acquired by the acquisition unit 63 is the first atmospheric pressure value, the correction value C is “1” in the example of FIG. 7.

In the example of FIG. 7, when the atmospheric pressure value acquired by the acquisition unit 63 is the first atmospheric pressure value, the supply amount control unit 61 transmits, to the drive unit 86, a control signal for rotationally driving the toner bottle 30 at the rotation speed Ra for a control time corresponding to a specified toner supply amount. Consequently, the controller 60 can supply the proper toner supply amount (the toner supply amount specified by the specification unit 64) to the developing device 13

When the atmospheric pressure value acquired by the acquisition unit 63 is the second atmospheric pressure value, the supply amount control unit 61 performs a second control on the supply member 87. The second control is control to supply a toner amount larger than a toner supply amount specified by the specification unit 64 to the developing device 13. In other words, the second control is control by the supply amount control unit 61 to transmit, to the drive unit 86, a control signal for supplying a toner amount larger than a toner supply amount specified by the specification unit 64 to the developing device 13. The “control to supply a toner amount of toner larger than a toner supply amount specified by the specification unit 64 to the developing device 13” is based on the fact that when the atmospheric pressure value acquired by the acquisition unit 63 is the second atmospheric pressure value, the correction value C is a value larger than one in the example of FIG. 7.

In the example of FIG. 7, when the atmospheric pressure value acquired by the acquisition unit 63 is the second atmospheric pressure value, the supply amount control unit 61 multiplies the rotation speed Ra by the correction value C larger than one, to calculate a rotation speed Rb after the correction. Then, the supply amount control unit 61 transmits, to the drive unit 86, a control signal for rotationally driving the toner bottle 30 at the rotation speed Rb after the correction for a control time corresponding to a specified toner supply amount. Thus, the controller 60 can supply a proper toner supply amount (the toner supply amount specified by the specification unit 64) to the developing device 13 to compensate for a decrease in the bulk density of the toner due to the atmospheric pressure value being lower than the first atmospheric pressure value.

The rotation speed Ra is also referred to as a “first rotation speed”, and the rotation speed Rb is also referred to as a “second rotation speed”. The rotation speed Rb (second rotation speed) is a rotation speed obtained by multiplying the rotation speed Ra (first rotation speed) by the correction value C (a value larger than one). Thus, the second rotation speed is higher than the first rotation speed.

In the above description, after a toner supply amount is specified, the supply amount control unit 61 determines a rotational drive time and a rotation speed from the specified toner supply amount, using the table of FIG. 7. However, the supply amount control unit 61 may calculate at least one of the rotational drive time and the rotation speed, using a predetermined equation.

Thus, when the atmospheric pressure value acquired by the acquisition unit 63 is the second atmospheric pressure value lower than the first atmospheric pressure value, the supply amount control unit 61 performs the control of the toner bottle 30 (supply member) at a rotation speed higher than the rotation speed of the toner bottle 30 at the first atmospheric pressure value. In other words, the supply amount control unit 61 changes a method of controlling the supply member based on the atmospheric pressure value acquired by the acquisition unit 63. In other words, the supply amount control unit 61 performs control based on the atmospheric pressure value acquired by the acquisition unit 63 (control according to the atmospheric pressure value acquired by the acquisition unit 63) on the supply member.

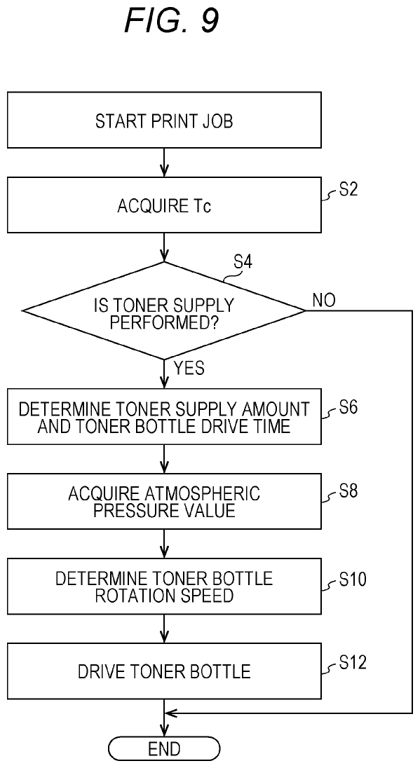

FIG. 9 is a diagram showing a flowchart of processing of the controller 60 of the image forming apparatus 100 in the present embodiment. The processing in FIG. 9 is executed, for example, when a print job is input from the operating panel 107 or when a print job is input by the user from an external device (e.g., a PC) of the image forming apparatus 100.

In step S2, the specification unit 64 acquires Tc detected by the toner concentration sensor. Next, in step S4, the specification unit 64 determines a used toner amount from the input job. Further, in step S4, the specification unit 64 determines whether to perform supply of the toner to the developing device 13, based on the proper range and a toner amount after subtraction calculated using equation (1) described above. If the specification unit 64 determines that toner supply should not be performed (NO in step S4), the processing in FIG. 9 ends. On the other hand, if the specification unit 64 determines that toner supply should be performed (YES in step S4), the processing proceeds to step S6.

In step S6, the specification unit 64 specifies a toner supply amount based on equation (2) described above. Further, in step S6, the supply amount control unit 61 specifies the rotational drive time of the toner bottle 30, based on the table of FIG. 7. When processing in step S6 is completed, the processing proceeds to step S8.

In step S8, the acquisition unit 63 acquires an atmospheric pressure value detected by the atmospheric pressure sensor 72. Next, in step S10, the supply amount control unit 61 determines the rotation speed of the toner bottle 30, based on the atmospheric pressure value acquired in step S8. In the example of FIG. 7, when the atmospheric pressure value acquired by the acquisition unit 63 is the first atmospheric pressure value (1 atm or higher), the supply amount control unit 61 sets the rotation speed to Ra. On the other hand, when the atmospheric pressure value acquired by the acquisition unit 63 is the second atmospheric pressure value (a value lower than the first atmospheric pressure value), the supply amount control unit 61 determines the correction value C corresponding to the second atmospheric pressure value, and multiplies the rotation speed Ra by the correction value C, thereby calculating the rotation speed Rb after the correction. The supply amount control unit 61 sets the rotation speed to the calculated rotation speed Rb. When step S10 is completed, the processing proceeds to step S12.

Next, in step S12, the supply amount control unit 61 rotates the toner bottle 30 at the rotation speed determined in step S10 for the drive time determined in step S6. Thus, the controller 60 can supply a proper toner supply amount (the toner supply amount specified by the specification unit 64) to the developing device 13 to compensate for a decrease in the bulk density of the toner due to the atmospheric pressure value being lower than the first atmospheric pressure value.

After the toner is supplied to the developing device 13 by the processing of FIG. 9 (after the processing in step S12 is executed), the controller 60 may check whether the toner concentration in the developing device 13 has fallen within the proper range. When the controller 60 determines that the toner concentration has not fallen within the proper range, the controller 60 executes the processing of FIG. 9 again. When the controller 60 determines that the toner concentration has not fallen within the proper range after the controller 60 has executed the processing of FIG. 9 a predetermined number of times, the controller 60 determines that the toner bottle 30 does not contain toner (the toner bottle 30 is empty). In this case, the controller 60 executes notification processing for notifying the user that the toner bottle 30 is empty. The notification processing is, for example, processing to output a predetermined sound (e.g., a beep).

In the above description, the image forming apparatus 100 executes the processing of the flowchart of the example of FIG. 9 when starting a print job. However, the image forming apparatus 100 may execute the processing of the flowchart of the example of FIG. 9 at another moment. For example, every time a predetermined period (e.g., one hour) has elapsed, the image forming apparatus 100 may execute the processing of the flowchart of the example of FIG. 9. In the processing of FIG. 9 in this case, the specification unit 64 does not determine a toner supply amount using equations (1) and (2), but determines whether Tc detected by the toner concentration sensor 73 falls within the proper range. If the specification unit 64 determines that Tc detected by the toner concentration sensor 73 falls within the proper range, the specification unit 64 determines that no toner should be supplied to the developing device 13. If the specification unit 64 determines that Tc detected by the toner concentration sensor 73 falls below the proper range, a toner supply amount is specified using equation (3) below, for example.

Toner supply amount=reference toner amount based on reference parts by weight−toner amount based on acquired Tc (3)

[Effects Achieved by Image Forming Apparatus of the Present Embodiment]

Next, effects achieved by the image forming apparatus 100 of the present embodiment will be described.

(A) In the present embodiment, the specification unit 64 specifies a toner supply amount of toner to be supplied from the toner bottle 30 to the developing device 13 (step S6). The acquisition unit 63 acquires the atmospheric pressure value. If the atmospheric pressure value acquired by the acquisition unit 63 is the first atmospheric pressure value (e.g., 1 atm), the supply amount control unit 61 executes the first control to supply the same toner amount as the specified toner amount to the developing device 13. On the other hand, if the atmospheric pressure value acquired by the acquisition unit 63 is the second atmospheric pressure value (an atmospheric pressure value lower than the first atmospheric pressure value, e.g., 0.9 atm), the supply amount control unit 61 executes the second control to supply a toner amount larger than the specified toner amount to the developing device 13. Thus, the supply amount control unit 61 changes the (supply member) control method based on the atmospheric pressure value acquired by the acquisition unit 63. Consequently, a proper toner supply amount (the toner supply amount specified by the specification unit 64) of toner can be supplied to the developing device 13 to compensate for a decrease in the bulk density of the toner due to the atmospheric pressure value being lower than the first atmospheric pressure value.

(B) When the atmospheric pressure value acquired by the acquisition unit 63 is the second atmospheric pressure value, the supply amount control unit 61 performs, as the second control, control based on the correction value C corresponding to the second atmospheric pressure value on the supply member 87. In the example of FIG. 7, the control based on the correction value C is control to rotate the toner bottle 30 at the rotation speed Rb after correction calculated by multiplying the rotation speed of the toner bottle 30 that is the control value by the correction value C. By the supply amount control unit 61 performing this control, even if the atmospheric pressure value acquired by the acquisition unit 63 is the second atmospheric pressure value, the supply amount control unit 61 can supply a toner amount corresponding to the second atmospheric pressure value to the developing device 13. Accordingly, the supply amount control unit 61 can supply an appropriate toner supply amount of toner to the developing device 13.

(C) By the way, if the atmospheric pressure value acquired by the acquisition unit 63 is low, it is conceivable to lengthen the control time (time to rotationally drive the toner bottle 30). However, if a job that uses a large amount of toner (e.g., a job with high coverage) is input, toner supply cannot keep up with it, and the print density becomes lighter than the print density input by the user. Therefore, in the present embodiment, as shown in FIG. 7, the control time is set to be the same regardless of the atmospheric pressure value acquired by the acquisition unit 63. Consequently, even if the atmospheric pressure value acquired by the acquisition unit 63 is low, the control time is not increased. As a result, it is possible to prevent the print density from becoming thinner than the print density input by the user.

(D) Since the spiral groove 30A is formed on the outer periphery of the bottle body 35 of the toner bottle 30 along the rotation axis A, the spiral protruding portion is formed on the inner wall (inner peripheral side) of the bottle body 35 along the rotation axis A. Since the toner bottle 30 has this shape, the toner in the toner bottle 30 can be properly supplied to the developing device 13 when the supply amount control unit 61 rotates the toner bottle 30. Thus, the supply amount control unit 61 can supply the toner to the developing device 13 with a simple structure. As a modification, without providing the groove 30A on the outer periphery of the bottle body 35 of the toner bottle 30, a spiral protruding portion may be provided on the inner wall (inner peripheral side) of the bottle body 35 along the rotation axis A.

### Second Embodiment

Next, a second embodiment will be described. An image forming apparatus of the second embodiment is different from the image forming apparatus of the first embodiment in that the image forming apparatus of the second embodiment includes toner bottles different from those of the image forming apparatus of the first embodiment.

In the description of the toner bottle 30 of the first embodiment, the spiral protruding portion is provided on the inner wall of the toner bottle 30 as a structure for conveying the toner contained in the toner bottle 30 to the opening 34. The second embodiment is an example in which a screw having the function of the protruding portion (the function of conveying the toner to the opening) is provided in the toner bottle.

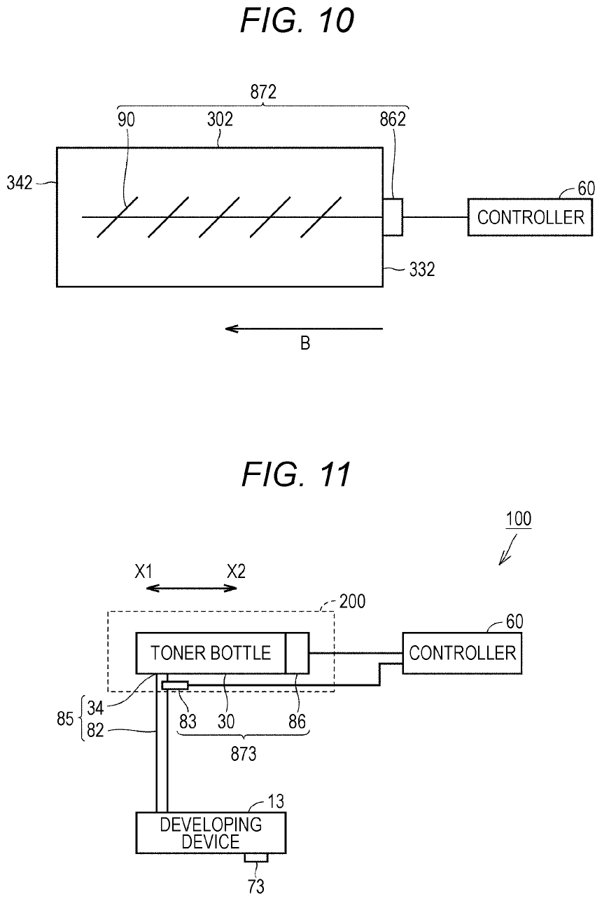

FIG. 10 is a diagram showing a structural example of a toner bottle 302 of the second embodiment. As shown in FIG. 10, the toner bottle 302 of the second embodiment has an opening 342 at one end. A drive unit 862 is disposed at the other end.

The toner bottle 302 has a screw 90 in the toner bottle 302. The screw 90 is for moving toner in the toner bottle 302 from the bottom 322 side toward the opening 342 (in the direction of arrow B in FIG. 10) by the rotation of the screw 90.

That is, while the spiral protruding portion in the toner bottle 30 has the function of conveying the toner in the toner bottle to the opening in the example of FIG. 4, the screw 90 has that function in the example of FIG. 10.

The supply amount control unit 61 of the controller 60 transmits a control signal to the drive unit 862 to rotationally drive the screw 90. By the rotational drive of the screw 90 by the controller 60, the toner in the toner bottle 302 is moved to the opening 342. The moved toner is supplied to the developing device 13 via the opening 342 and a supply path. The toner bottle 302, the drive unit 862, and the screw 90 are also collectively referred to as a supply member 872.

A table in the second embodiment is similar to that in FIG. 7. While the “rotation speed Ra” in FIG. 7 is the “rotation speed of the toner bottle 30” in the first embodiment, it is the “rotation speed of the screw 90” in the second embodiment. Thus, in the second embodiment, the control value is the rotation speed of the screw 90.

According to the image forming apparatus of the present embodiment, the screw 90 rotated is installed in the toner bottle 302. Since the toner bottle 302 includes the screw 90 like this, the toner in the toner bottle 302 can be properly supplied to the developing device 13 when the supply amount control unit 61 rotates the screw 90.

If the atmospheric pressure value acquired by the acquisition unit 63 is the first atmospheric pressure value (e.g., 1 atm), the supply amount control unit 61 performs, on the supply member 872, the first control to supply a supply amount of toner specified by the specification unit 64 to the developing device 13. The first control is, for example, control to rotate the screw 90 at the rotation speed Ra (first rotation speed).

If the atmospheric pressure value acquired by the acquisition unit 63 is the second atmospheric pressure value (an atmospheric pressure value lower than the first atmospheric pressure value), the supply amount control unit 61 performs, on the supply member 872, the second control to supply a toner supply amount of toner larger than the toner supply amount specified by the specification unit 64 to the developing device 13. The second control is, for example, control to rotate the screw 90 at the rotation speed Rb (second rotation speed) obtained by multiplying the rotation speed Ra by the correction value C larger than one.

Thus, when the atmospheric pressure value acquired by the acquisition unit 63 is the second atmospheric pressure value lower than the first atmospheric pressure value, the supply amount control unit 61 performs the control of the screw 90 at a rotation speed higher than the rotation speed of the screw 90 at the first atmospheric pressure value. In other words, the supply amount control unit 61 changes a method of controlling the screw 90 included in the toner bottle 30 based on the atmospheric pressure value acquired by the acquisition unit 63.

Consequently, a proper toner supply amount (the toner supply amount specified by the specification unit 64) can be supplied to the developing device 13 to compensate for a decrease in the bulk density of the toner due to the atmospheric pressure value being lower than the first atmospheric pressure value.

The screw 90 is not limited to the one extending in the rotation axis A direction as in the second embodiment, and may be any screw that can supply the toner to the developing device 13 by rotation. For example, the screw may be a small screw. The small screw may be installed at the bottom 322. The screw 90 may be a concept included in the supply member, or may be a concept not included in the supply member.

### Third Embodiment

FIG. 11 is a diagram showing simplified principal parts of an image forming apparatus of a third embodiment. As shown in FIG. 11, the opening 34 and the supply path 82 are collectively referred to as a “supply port 85 of the toner bottle 30” or simply as a “supply port 85”. In the description of the first embodiment, the supply amount control unit 61 controls the amount of toner to be supplied according to the rotation speed of the toner bottle 30. In the description of the second embodiment, the supply amount control unit 61 controls the amount of toner to be supplied according to the rotation speed of the screw 90. In the third embodiment, the supply amount control unit 61 controls the amount of toner to be supplied according to the opening width of the supply port 85. The controller 60 rotates the toner bottle 30 via the drive unit 86.

As shown in FIG. 11, the image forming apparatus of the present embodiment includes an opening width adjustment member 83. The opening width adjustment member 83 is movable in an X1 direction and an X2 direction in FIG. 11. The opening width adjustment member 83 can adjust the opening width of the supply port 85. In the example of FIG. 11, the opening width adjustment member 83 is described as a member that can adjust the path width of the supply path 82 of the supply port 85. As a modification, the opening width adjustment member 83 may be a member that can adjust the opening width of the opening 34 of the supply port 85.

The supply amount control unit 61 rotationally drives the toner bottle 30 and can move the opening width adjustment member 83 in the X1 direction and the X2 direction. By the opening width adjustment member 83 moving in the X2 direction, the opening width of the supply port 85 is increased. By the opening width adjustment member 83 moving in the X1 direction, the opening width of the supply port 85 is reduced.

When the supply amount control unit 61 rotationally drives the toner bottle 30 with the opening width increased (with the opening width adjustment member 83 moved in the X2 direction), a large amount of toner can be supplied to the developing device 13. On the other hand, when the supply amount control unit 61 rotationally drives the toner bottle 30 with the opening width reduced (with the opening width adjustment member 83 moved in the X1 direction), a small amount of toner can be supplied to the developing device 13. Thus, in the third embodiment, the control value is the opening width of the supply port 85. A supply member 873 includes the opening width adjustment member 83, the toner bottle 30, and the drive unit 86.

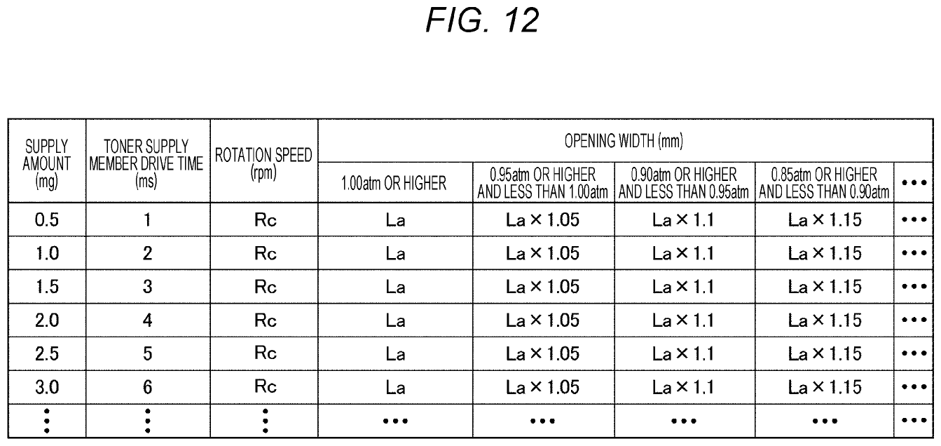

FIG. 12 is an example of a table used by the image forming apparatus of the present embodiment. In the example of FIG. 12, the rotation speed of the toner bottle 30 is set to a rotation speed Rc regardless of the toner supply amount and the pressure value acquired by the acquisition unit 63. In the example of FIG. 12, the rotational drive time of the toner bottle 30 is determined according to the toner supply amount.

In the example of FIG. 12, the correction value C by which the opening width is multiplied is determined. When the atmospheric pressure value P under which the image forming apparatus 100 of the present embodiment is disposed is 1.00 atm or larger, the correction value C is set to “1”. When the atmospheric pressure value P is 0.95 atm or higher and less than 1.00 atm, the correction value C is set to “1.05”. When the atmospheric pressure value P is 0.90 atm or higher and less than 0.95 atm, the correction value C is set to “1.10”. When the atmospheric pressure value P is 0.85 atm or higher and less than 0.9 atm, the correction value C is set to “1.15”.

For example, when the atmospheric pressure value P acquired by the acquisition unit 63 is 1.00 atm or higher, the opening width is an opening width La. When the atmospheric pressure value P is 0.95 atm or higher and less than 1.00 atm, the opening width is set to La×1.05 (the correction value C is set to “1.05”).

As shown in FIG. 12, the lower the atmospheric pressure value acquired by the acquisition unit 63, the larger the correction value C is set to be.

According to the image forming apparatus of the present embodiment, if the atmospheric pressure value acquired by the acquisition unit 63 is the first atmospheric pressure value (e.g., 1.00 atm), first control to supply a toner supply amount of toner specified by the specification unit 64 to the developing device 13 is performed on the supply member 873. The first control is, for example, control to rotate the toner bottle 30 at the rotation speed Rc for a drive time corresponding to a toner supply amount specified by the specification unit 64, with the opening width set to La.

When the atmospheric pressure value acquired by the acquisition unit 63 is the second atmospheric pressure value (an atmospheric pressure value lower than the first atmospheric pressure value), second control to supply a supply amount of toner larger than a toner supply amount specified by the specification unit 64 to the developing device 13 is performed on the supply member 873. The second control is, for example, control to rotate the toner bottle 30 at the rotation speed Rc for a drive time corresponding to a toner supply amount specified by the specification unit 64, with the opening width set to La×the correction value C larger than one. The correction value C is a value corresponding to the atmospheric pressure value acquired by the acquisition unit 63.

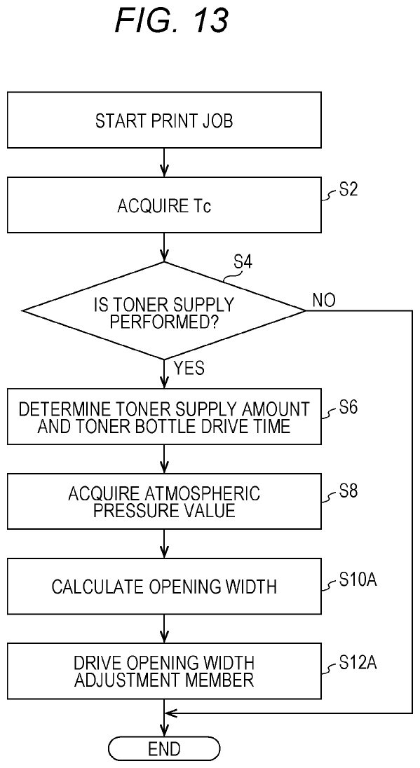

FIG. 13 is a flowchart of processing of the image forming apparatus in the present embodiment. When the flowchart of FIG. 13 is compared with the flowchart of FIG. 9, the flowchart of FIG. 13 is different from the flowchart of FIG. 9 in that step S10 and step S12 of FIG. 9 are replaced with step S10A and step S12A.

After the processing in step S8 is completed, the processing proceeds to step S10A. In step S10A, the supply amount control unit 61 determines the opening width of the supply port 85, based on the atmospheric pressure value acquired in step S8. In the example of FIG. 12, when the atmospheric pressure value acquired by the acquisition unit 63 is the first atmospheric pressure value (1 atm or higher), the supply amount control unit 61 sets the opening width to La. On the other hand, when the atmospheric pressure value acquired by the acquisition unit 63 is the second atmospheric pressure value (a value lower than the first atmospheric pressure value), the supply amount control unit 61 determines the correction value C corresponding to the second atmospheric pressure value, and multiplies the opening width La by the correction value C, thereby calculating an opening width Lb after the correction. The supply amount control unit 61 sets the opening width to the calculated opening width Lb. When step S10 is completed, the processing proceeds to step S12A.

Next, in step S12A, the supply amount control unit 61 sets the opening width of the supply port 85 to the opening width determined in step S10A. In step S12A, the toner bottle 30 is rotated at the rotation speed Rc for the drive time determined in step S6 with the opening width of the supply port 85 set to the opening width determined in step S10A.

Thus, when the atmospheric pressure value acquired by the acquisition unit 63 is the second atmospheric pressure value lower than the first atmospheric pressure value, the supply amount control unit 61 performs the control of the supply member 873 with an opening width larger than the opening width of the supply port 85 at the first atmospheric pressure value. In other words, the supply amount control unit 61 changes a control method for the opening width of the supply port 85 based on the atmospheric pressure value acquired by the acquisition unit 63. Thus, the controller 60 can supply a proper toner supply amount (the toner supply amount specified by the specification unit 64) to the developing device 13 to compensate for a decrease in the bulk density of the toner due to the atmospheric pressure value being lower than the first atmospheric pressure value.

Further, in the present embodiment, the rotation speed of the toner bottle 30 can be made uniform regardless of the atmospheric pressure value acquired by the acquisition unit. Consequently, a processing load related to the drive of the toner bottle 30 can be reduced.

As a modification of the image forming apparatus of the present embodiment, the structure of the toner bottle may be the structure described in the second embodiment, that is, the toner bottle 302 including the screw 90. The supply port 85 may be a concept included in the supply member, or may be a concept not included in the supply member.

### Fourth Embodiment

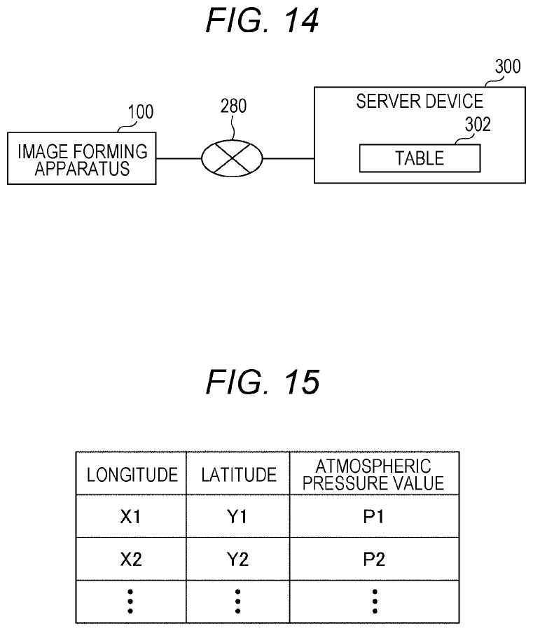

FIG. 14 is a configuration example of an image forming system of a fourth embodiment. In the example of FIG. 14, the image forming system includes the image forming apparatus 100, a server device 300, and a network 280. In the descriptions of the first to third embodiments, the atmospheric pressure sensor 72 detects the atmospheric pressure value in the position where the image forming apparatus 100 is installed. In the fourth embodiment, the server device 300 detects the atmospheric pressure value in the position where the image forming apparatus 100 is installed.

For example, in step S8 of FIG. 9 and FIG. 13, the image forming apparatus 100 requests the atmospheric pressure value in the position where the image forming apparatus 100 is installed from the server device 300. For the request, for example, the image forming apparatus 100 transmits a request signal to the server device 300 via the network 280. The request signal includes position information of the image forming apparatus 100 that is the transmission source of the request signal. The position information is information indicating the position where the image forming apparatus 100 is installed. The position information typically includes the latitude and longitude of the position where the image forming apparatus 100 is installed.

The server device 300 holds an atmospheric pressure value table. FIG. 15 is a diagram showing an example of the atmospheric pressure value table. In the example of FIG. 15, the atmospheric pressure value P is associated with latitude X and longitude Y. The server device 300 updates the atmospheric pressure value table every time a predetermined period of time has elapsed (e.g., every time one day has elapsed).

When the server device 300 acquires the request information, the server device 300 acquires the position information included in the request information. The server device 300 acquires an atmospheric pressure value corresponding to the position information, referring to the atmospheric pressure value table in FIG. 15. The acquired atmospheric pressure value is the atmospheric pressure value in the position where the image forming apparatus 100 that has transmitted the request information is disposed. The server device 300 transmits the acquired atmospheric pressure value to the image forming apparatus 100 as the request source. The image forming apparatus 100 acquires the acquired atmospheric pressure value and executes the subsequent processing.

According to the image forming apparatus 100 of the present embodiment, the atmospheric pressure value can be acquired from an external device (the server device 300), and thus the image forming apparatus 100 does not need to include an atmospheric pressure value sensor. Thus, the number of components of the image forming apparatus 100 can be reduced.

### Other Embodiments

In the descriptions of the above embodiments, when the atmospheric pressure value acquired by the acquisition unit 63 is the second atmospheric pressure value lower than the first atmospheric pressure value, the supply amount control unit 61 performs the control of the supply member (the toner bottle 30) at a rotation speed higher than the rotation speed of the supply member at the first atmospheric pressure value. However, when the atmospheric pressure value acquired by the acquisition unit 63 is the second atmospheric pressure value lower than the first atmospheric pressure value, the supply amount control unit 61 may perform the control of the supply member (the toner bottle 30) for a rotational drive time longer than the rotational drive time of the supply member at the first atmospheric pressure value. In this case, for example, the table of FIG. 7 is changed to a table in which the lower the atmospheric pressure value acquired by the acquisition unit, the longer the rotational drive time of the toner bottle, regardless of the supply amount.

As a modification, when the atmospheric pressure value acquired by the acquisition unit 63 is the second atmospheric pressure value lower than the first atmospheric pressure value, the supply amount control unit 61 may perform the control of the supply member (the toner bottle 30) for a rotational drive time longer than the rotational drive time of the supply member at the first atmospheric pressure value, and at a rotation speed higher than the rotation speed of the supply member at the first atmospheric pressure value.

In the descriptions of the above embodiments, when the atmospheric pressure value acquired by the acquisition unit 63 is the second atmospheric pressure value lower than the first atmospheric pressure value, the supply amount control unit 61 performs the control of the screw 90 at a rotation speed higher than the rotation speed of the screw 90 at the first atmospheric pressure value. However, when the atmospheric pressure value acquired by the acquisition unit 63 is the second atmospheric pressure value lower than the first atmospheric pressure value, the supply amount control unit 61 may perform the control of the screw 90 for a rotational drive time longer than the rotational drive time of the screw 90 at the first atmospheric pressure value. In this case, for example, the table of FIG. 7 is changed to a table in which the lower the atmospheric pressure value acquired by the acquisition unit, the longer the rotational drive time of the screw 90, regardless of the supply amount.

As a modification, when the atmospheric pressure value acquired by the acquisition unit 63 is the second atmospheric pressure value lower than the first atmospheric pressure value, the supply amount control unit 61 may perform the control of the supply member for a rotational drive time longer than the rotational drive time of the screw 90 at the first atmospheric pressure value, and at a rotation speed higher than the rotation speed of the screw 90 at the first atmospheric pressure value.

In other words, based on the above-described embodiments, when the atmospheric pressure value acquired by the acquisition unit 63 is the first atmospheric pressure value, the supply amount control unit 61 may set the “drive amount to the supply member per unit time” to a first drive amount. When the atmospheric pressure value acquired by the acquisition unit 63 is the second atmospheric pressure value lower than the first atmospheric pressure value, the supply amount control unit 61 may set the “drive amount to the supply member per unit time” to a second drive amount larger than the first drive amount. In other words, when the atmospheric pressure value acquired by the acquisition unit 63 is the second atmospheric pressure value lower than the first atmospheric pressure value, the supply amount control unit 61 may perform the control of the supply member at the “drive amount to the supply member per unit time (second drive amount)” larger than the “drive amount to the supply member per unit time (first drive amount)” of the supply member at the first atmospheric pressure value. Here, the drive includes, for example, at least one of drive to the supply member (the toner bottle 30 or the screw) and drive of the screw 90. That is, the drive amount per unit time (e.g., one second) includes at least one of the driving speed of the toner bottle 30 and the driving speed of the screw 90.

In other words, based on the above-described embodiments, when the atmospheric pressure value acquired by the acquisition unit 63 is the first atmospheric pressure value, the supply amount control unit 61 may set the “drive amount to the supply member during a supply period” to a first drive amount. When the atmospheric pressure value acquired by the acquisition unit 63 is the second atmospheric pressure value lower than the first atmospheric pressure value, the supply amount control unit 61 may set the “drive amount to the supply member during a supply period” to a second drive amount larger than the first drive amount. In other words, when the atmospheric pressure value acquired by the acquisition unit 63 is the second atmospheric pressure value lower than the first atmospheric pressure value, the supply amount control unit 61 may perform the control of the supply member at a “drive amount to the supply member during a supply period (second drive amount)” larger than the “drive amount to the supply member during the supply period (first drive amount)” of the supply member at the first atmospheric pressure value. Here, the supply period is a period during which the developer is supplied from the supply member to the developing device 13. That is, the drive amount to the supply member during the supply period includes at least one of the drive time of the toner bottle 30, the drive time of the screw 90, and the opening width of the opening 34.

<Modification>

Next, a modification will be described. As the method for supplying the toner contained in the toner bottle to the developing device 13, in the description of the first embodiment, the toner bottle 30 having the spiral protruding portion on the inner peripheral surface is rotationally driven. In the description of the second embodiment, the screw 90 in the toner bottle 302 is rotationally driven. In the description of the third embodiment, the opening width adjustment member 83 is driven. However, another method may be used for supplying the toner to the developing device 13.

For example, the image forming apparatus may use a pump that force-feeds the toner contained in the toner bottle with air or the like. In this case, the pump is provided in a place opposite to the place where the opening of the toner bottle is provided.

In this case, for example, in the table of FIG. 7, pump drive time (force-feed time) is associated with the toner supply amount. Further, if the atmospheric pressure value acquired by the acquisition unit 63 is 1 atm or higher, the force-feed amount of the pump is set to “Rd”. If the atmospheric pressure value acquired by the acquisition unit 63 is less than 1 atm, the correction value C corresponding to the atmospheric pressure value is associated.

Processing of the modification will be described with the flowchart of FIG. 9. Step S10 is changed to step S10B in which the supply amount control unit 61 determines the force-feed amount of the pump. In step S12, the supply amount control unit 61 causes the pump to force-feed the toner at the force-feed amount determined in step S10B for the drive time determined in step S6. Thus, even when the pump is used, the controller 60 can supply a proper toner supply amount (the toner supply amount specified by the specification unit 64) to the developing device 13 to compensate for a decrease in the bulk density of the toner due to the atmospheric pressure value being lower than the first atmospheric pressure value.

In the above-described embodiments, the embodiment in which the acquisition unit 63 acquires the atmospheric pressure value from the atmospheric pressure sensor 72 and the embodiment in which the acquisition unit 63 acquires the atmospheric pressure value from the server device 300 have been described. However, for example, in a situation where the atmospheric pressure value in the installation location of the image forming apparatus is not changed, for example, when the image forming apparatus is installed, a service person or the like may measure the atmospheric pressure value, and the storage unit 62 may store the atmospheric pressure value. In this case, the acquisition unit 63 acquires the atmospheric pressure value stored in the storage unit 62. When the atmospheric pressure value is changed from the value in the current location, for example, when the image forming apparatus that is currently installed on level ground is installed on high ground, a service person or the like may measure the atmospheric pressure value again when the image forming apparatus is installed on high ground, and the storage unit 62 may store the atmospheric pressure value.

In the descriptions of the above embodiments, the specification unit 64 acquires the toner concentration. However, the specification unit 64 may acquire another concentration of the developer. For example, the specification unit 64 may acquire the carrier concentration. In this case, a carrier concentration sensor is provided instead of the toner concentration sensor 73.

In the descriptions of the above-described embodiments, the developer is the toner and the carrier. However, the developer may be another material. For example, the developer may be toner without containing carrier.

In the descriptions of the above embodiments, when the atmospheric pressure value acquired by the acquisition unit 63 is lower than 1 atm, the drive value is multiplied by the correction value C, and control is performed on the supply member at the drive value after the multiplication. However, when the atmospheric pressure value acquired by the acquisition unit 63 is lower than 1 atm, control may be performed on the supply member at a drive value corresponding to the atmospheric pressure value lower than 1 atm without using the correction value C.

In the descriptions of the above embodiments, the supply member is the toner bottle 30. However, the supply member may be any member that supplies toner. For example, toner may be temporarily supplied from a toner bottle to a sub bottle, and the toner may be supplied from the sub-bottle to a developing device. In this case, the supply member may be the sub-bottle.

As a modification of the above-described embodiments, when the atmospheric pressure value acquired by the acquisition unit 63 is the second atmospheric pressure value lower than the first atmospheric pressure value, the supply amount control unit 61 may perform the control of the supply member at a rotation speed lower than the rotation speed of the supply member at the first atmospheric pressure value. When the atmospheric pressure value acquired by the acquisition unit 63 is the second atmospheric pressure value lower than the first atmospheric pressure value, the supply amount control unit 61 may perform the control of the supply member for a rotational drive time shorter than the rotational drive time of the supply member at the first atmospheric pressure value. When the atmospheric pressure value acquired by the acquisition unit 63 is the second atmospheric pressure value lower than the first atmospheric pressure value, the supply amount control unit 61 may perform the control of the screw at a rotation speed lower than the rotation speed of the screw at the first atmospheric pressure value. When the atmospheric pressure value acquired by the acquisition unit 63 is the second atmospheric pressure value lower than the first atmospheric pressure value, the supply amount control unit 61 may perform the control of the screw for a rotational drive time longer than the rotational drive time of the screw at the first atmospheric pressure value. When the atmospheric pressure value acquired by the acquisition unit 63 is the second atmospheric pressure value lower than the first atmospheric pressure value, the supply amount control unit 61 may perform the control of the supply member with an opening width smaller than the opening width of the supply port at the first atmospheric pressure value.

Although embodiments of the present invention have been described and illustrated in detail, the disclosed embodiments are made for purposes of illustration and example only and not limitation. The scope of the present invention should not be interpreted by terms of the above descriptions but by terms of the appended claims, and is intended to include all modifications within meaning and scope equivalent to the scope of the claims

What is claimed is:

1. An image forming apparatus, comprising:
a latent image carrier on which a latent image is formed;
a developing device that develops the latent image formed on the latent image carrier, using developer;
a supply member that supplies the developer to the developing device; and
a hardware processor that:
performs control of the supply member; and
acquires an atmospheric pressure value in a position where the image forming apparatus is installed,
wherein the hardware processor changes a method of controlling the supply member based on the atmospheric pressure value acquired by the hardware processor.

2. The image forming apparatus according to claim 1, wherein
the supply member rotates to supply the developer to the developing device, and
when the atmospheric pressure value acquired by the hardware processor is a second atmospheric pressure value lower than a first atmospheric pressure value, the hardware processor performs the control of the supply member at a rotation speed higher than a rotation speed of the supply member at the first atmospheric pressure value.

3. The image forming apparatus according to claim 1, wherein
the supply member rotates to supply the developer to the developing device, and
when the atmospheric pressure value acquired by the hardware processor is a second atmospheric pressure value lower than a first atmospheric pressure value, the hardware processor performs the control of the supply member for a rotational drive time longer than a rotational drive time of the supply member at the first atmospheric pressure value.

4. The image forming apparatus according to claim 1, wherein
the supply member supplies the developer to the developing device by rotation of a screw installed in the supply member, and
when the atmospheric pressure value acquired by the hardware processor is a second atmospheric pressure value lower than a first atmospheric pressure value, the hardware processor performs control of the screw at a rotation speed higher than a rotation speed of the screw at the first atmospheric pressure value.

5. The image forming apparatus according to claim 1, wherein
the supply member supplies the developer to the developing device by rotation of a screw installed in the supply member, and
when the atmospheric pressure value acquired by the hardware processor is a second atmospheric pressure value lower than a first atmospheric pressure value, the hardware processor performs control of the screw for a rotational drive time longer than a rotational drive time of the screw at the first atmospheric pressure value.

6. The image forming apparatus according to claim 1, wherein
the supply member supplies the developer to the developing device by opening of a supply port provided to the supply member, and
when the atmospheric pressure value acquired by the hardware processor is a second atmospheric pressure value lower than a first atmospheric pressure value, the hardware processor performs the control of the supply member with an opening width larger than an opening width of the supply port at the first atmospheric pressure value.

7. The image forming apparatus according to claim 1, further comprising a sensor that detects the atmospheric pressure value,
wherein the hardware processor acquires the atmospheric pressure value from the sensor.

8. The image forming apparatus according to claim 1, wherein the hardware processor acquires the atmospheric pressure value from an external device.

9. A control method of controlling an image forming apparatus comprising a developing device that develops a latent image formed on a latent image carrier using developer, the method comprising:
acquiring an atmospheric pressure value in a position where the image forming apparatus is installed; and
changing a method of controlling supply of the developer to the developing device, based on the acquired atmospheric pressure value.
